(19) United States
(12) Patent Application Publication
(10) Pub. No.: US 2008/0089990 A1
(43) Pub. Date: Apr. 17, 2008

(54) Method for Producing a Vegetable Protein Ingredient for Ice Cream and Ice Cream Containing Said Protein Ingredient

(75) Inventors: Peter Eisner, Freising (DE); Klaus Muller, Freising (DE); Udo Knauf, Munchen (DE); Gerhard Kloth, Neuendorf (DE)

Correspondence Address: BREINER & BREINER, L.L.C., P.O. BOX 320160, ALEXANDRIA, VA, 22320-0160, US

(73) Assignee: FRAUNHOFER-GESELLSCHAFT ZUR FORDERUNG, MUNCHEN (DE)

(21) Appl. No.: 11/795,413

(22) PCT Filed: Jan. 17, 2006
(86) PCT No.: PCT/DE06/00054

§ 371 Date: Oct. 9, 2007

(30) Foreign Application Priority Data
Jan. 18, 2005 (DE) 10 2005 002 429.7

(51) Int. Cl. A23G 9/38; A23C 11/10

(52) U.S. Cl. 426/565; 426/424; 426/431

(57) ABSTRACT

The invention relates to a method for producing a vegetable protein ingredient for ice cream. According to said method, in a protein extraction step, part of the lupin protein contained in crushed lupin seeds is dissolved or at least dispersed in an aqueous phase, any fibres contained in the aqueous phase are separated and the lupin protein is separated from the aqueous phase in order to obtain the protein ingredient. The invention is characterised in that for the protein extraction step a pH value of 6≦pH<7 is set for the aqueous phase. The invention also relates to a preferably pure vegetable ice cream containing the protein ingredient obtained from lupins. The ice cream has a texture in the mouth that is comparable to that of conventional ice cream and that in part surpasses the quality criteria of the latter in terms of sensitivity to cold and creamy texture.

### FIELD OF APPLICATION

The invention relates to a method for producing a vegetable protein ingredient for ice cream, wherein lupin seeds are provided and firstly crushed, in at least one protein extraction step part of the lupin protein contained in crushed lupin seeds is dissolved or at least dispersed in an aqueous phase, fibres present in the aqueous phase are separated, and the lupin protein is separated from the aqueous phase in order to obtain the protein ingredient. The invention also relates to an ice cream which contains the protein ingredient of lupins.

### PRIOR ART

Ice cream and other creamy ice cream variants contain animal or vegetable fats and milk protein and/or lactose and partially egg protein. In ice cream milk and egg proteins fulfil the function of giving texture in addition to a possibly desired taste. The production of ice cream occurs substantially by weighing the ingredients, pre-mixing, homogenising, pasteurising, cooling down (+4° C.), maturing, freezing, packing and storing.

Amongst others ice cream is known such as e.g. ice cream with eggs (at least 50% milk and at least 270 g of whole egg or 90 g egg yolk per litre of milk), ice cream with cream (at least 18% milk fat from cream), ice cream (at least 10% milk fat) simple ice cream (at least 3% milk fat), milk ice (at least 70% milk) and ice cream with vegetable fat (at least 3% vegetable fat). All of the mentioned types of ice cream have in common, that in addition to animal or vegetable fats they also contain milk protein and lactose. However, many people are allergic to dairy products and other animal ingredients such that they should avoid eating milk ice and ice cream with cream. For this consumer group there has been no alternative to ice cream containing milk with an equal taste value.

The creaminess is particularly important for the taste value when consuming ice cream. Said creaminess is determined by the fat content and its integration into the entire matrix. Moreover, the viscosity of the melt determines the creaminess of the ice cream. A melt with higher viscosity is perceived as more creamy in the mouth than a melt with lower viscosity.

Additionally, the melting off behaviour determines the organoleptic sensation when consuming ice cream. An ice cream with a slow and even melting off behaviour is perceived more palatable than an ice cream with a heterogeneous and partly very fast melting off behaviour. A further, very important quality parameter is the mouth feel and the sensitivity to cold during consumption. With insufficient emulsion effect and water binding of the matrix, bigger ice crystals form which creates a rough mouth feel and a watery impression. The sensitivity to cold is also codetermined by the availability of fat.

In the prior art, creamy ice cream types are only achievable through greater amounts of fat, the sensation of creaminess being achieved if the fat content is more than 15% by weight, more preferable more than 20% by weight.

In previously known ice cream preparations with vegetable protein content, particularly on the basis of soya, attempts were made to replace animal emulsifiers with vegetable proteins. For this, dried vegetable proteins, which were obtained by conventional aqueous or aqueous-alcoholic extraction methods and subsequent drying as powder, were employed.

Some of the protein products being employed were produced from flours from protein seed in aqueous extraction steps. Since the fibre fraction in flours is present in particulate, micro-milled form it may not be completely separated from the protein solution before drying according to the prior art. Therefore, when using such proteins, fibres are brought in the ice cream.

Also, experiments for producing ice cream with fermented protein ingredients have been described. However, they contain lactic acid in high concentrations and in many cases diacetyl, which is often undesired and not accepted by the consumer.

Acceptable sensory characteristics are obtained in vegetable ice cream types if a certain proportion of ingredients of animal origin are added, such as milk fractions or animal proteins, e.g. casein or caseinates. In this case, the consumer is provided with a quite appealing ice cream, however, it is not purely vegetable.

WO 2004/093560 A1, for example, shows a method for producing a vegetable protein ingredient on the basis of lupin proteins, wherein lupin seeds are crushed to lupin flour and part of the lupin proteins contained in the lupin flour are dissolved in an alkaline aqueous phase in a protein extraction step. The lupin protein is separated from the aqueous phase through precipitation and dissolved again in a suitable medium in order to obtain the protein ingredient. For producing an ice cream with this ingredient Coffee-mate®, which contains milk protein, is added.

Comparative tests with the above-mentioned vegetable products according to the prior art show clear sensory weaknesses of the products compared to conventional ice cream on the basis of milk ingredients. It has not been possible to obtain particularly the creaminess and mouth feel of conventional ice cream with vegetable ice cream. For this reason vegetable ice cream is a largely unknown niche product in supermarkets.

Ice cream products according to the prior art produced from vegetable protein ingredients present some disadvantages to the consumer. Thus, if soya is employed, the consumer is uncertain as to whether genetically modified ingredients are contained in the product. According to present findings with soya, this can no longer be excluded even with cultivation of natural species or organic farming.

Employing dried protein ingredients has so far yielded sensory disadvantages since in all known drying processes oxidation procedures take place. The resulting oxidation products in the protein ingredient reduce the feeling of quality, e.g. through a feeling of rancidness. Moreover, drying aqueous proteins always leads to a clear reduction in solubility of the protein. When adding poorly soluble protein ingredients to the recipe of an ice cream a protein suspension, which contains insoluble protein particles and agglomerates, which is perceived as rough in the mouth, is created. Reduced solubility often involves a reduction of the technical functionality, particularly the emulsifying characteristics. Thus, they cannot contribute towards stabilising the phase interface and increasing creaminess.

When fibrous ingredients such as e.g. on the basis of vegetable protein flours or other fibrous protein ingredients are employed it also creates a rough mouth feel since the fibres in the ice cream are not dissolved but are present in dispersed form.

The subjective taste value, creaminess and mouth feel, which are achievable with such products, are comparable to the taste value of ice cream containing milk protein.

### OBJECT OF THE INVENTION

It is the object of the present invention to provide an ice cream which can also be produced without egg products, lactose, animal protein, animal fat and other ingredients of animal origin and is still organoleptically appealing and has a comparable or improved taste value compared to ice cream with animal ingredients in relation to creaminess, mouth feel, melting off behaviour and sensitivity to cold.

### IDENTIFICATION OF THE INVENTION

The object is solved by the method for producing a protein ingredient for an ice cream and the ice cream produced with said protein ingredient according to claims 1 to 14. Particularly advantageous embodiments of the method and of the ice cream are subject-matter of the sub-claims and may be taken from the following description.

In the proposed method for producing a vegetable protein ingredient for an ice cream, subsequently also referred to as ingredient or lupin ingredient, firstly, lupin seeds are crushed. Said lupin seeds may be employed in a hulled or non-hulled condition. Then, in a protein extraction step part of the lupin protein contained in crushed lupin seeds is dissolved or at least finely dispersed in an aqueous phase, the pH value of the aqueous phase being set between 6 and 7. Subsequently, the fibres may be separated from the protein solution, preferably by means of mechanical methods. Finally, the lupin protein is separated from the aqueous phase, which is now free from fibres. Preferably, this occurs through methods according to the prior art, such as e.g. through precipitation or separation of the precipitated protein containing fraction from the aqueous fraction. It is understood that additional method steps for gaining the described ingredient are possible.

The ice cream according to the invention having said protein ingredient, preferably a purely vegetable ice cream, contains lupin protein as a protein fraction and vegetable oil or vegetable fat as a fat fraction. Through the aqueous extraction step during production of the ingredient with acid pH values in the pH range between pH 6 and less than pH 7, preferably pH 6.8, a particularly tasteless and colourless ice is obtained. Thus, substances, which tend towards colour reactions when alkaline, are not reacted and a near white ice cream colour may be obtained.

Employing an ingredient, which contains lupin protein in conjunction with lupin oil, is particularly advantageous. This may be achieved by not subjecting the lupin seeds or crushed lupin seeds to defatting or deoiling before the protein extraction step, such that the separated ingredient also contains lupin oil when separating the lupin proteins from the solution.

Surprisingly, merely on the basis of the ingredient produced according to the method from lupin protein with lupin oil, if applicable, after the addition of a further vegetable oil, an ice cream, which is very appealing from a sensory point of view, may be produced without further ingredients of animal origin. On the basis of the above lupin ingredient a purely vegetable ice cream may be provided for the first time which has a mouth feel that is comparable to that of conventional (premium) ice cream and even partially surpasses the quality parameters with regard to the sensitivity to cold and creaminess. By means of further vegetable ingredients such as sugar, thickening agents and natural colourings, flavourings and further vegetable ingredients a variety of tastes of the lupin ice cream types may be produced which meet the highest quality requirements.

Particularly sensory advantages are obtained if the lupin oil contained in the above described ingredient is from the same lupin seeds as the lupin protein. By combining those two vegetable fractions from the same seed, extremely advantageous interactions with a techno-functional effect between protein and oil and, if applicable, the additionally added oils and fats are formed. This results in a particularly stable, smooth and creamy ice cream structure which adds to the enhancement of the taste value.

Oils from legumes such as lupin or soya arise as additionally added vegetable oils. Oils from oilseed or oleaginous fruit such as rapeseed, sunflower, linseed, palm and olive in native form, refined form and in individual cases also in hardened form may be employed. It is also possible to employ other vegetable oils or fats. Particular nutrition-physiological advantages are obtained when employing oils with more than 80% by weight unsaturated fatty acids, more preferably >90% by weight. The total fat content in lupin ice cream is advantageously set to values between 3 to 20% by weight, particularly advantageously 6 to 12% by weight.

It has been shown that in various recipes the mentioned mixtures of lupin oil and lupin protein, which is from the same seed, provide many advantages as an ingredient for the ice cream. The proportion of lupin oil in relation to the mass of lupin protein should thus be at least 1.5% by weight. A particularly good creaminess is obtained if more than 5% by weight, more preferably more than 10% by weight of lupin oil is contained in the protein. Thus, it has been shown, that particularly creamy textures are obtained if no methods for separating the lupin oil from the lupin seed are employed before the separation of lupin protein and lupin fibres.

Particularly appealing organoleptic characteristics of the ice cream are obtained when employing sweet lupins, particularly when employing blue or white lupins having alkaloid contents <0.01% by weight, more preferably <0.001% by weight. Lupin seeds that are particularly suitable from a sensory point of view are from climatic conditions of Central Europe, e.g. from German cultivation.

In particular, lupin types with a reduced fat content <15% by weight, more preferably <10% by weight in the seed are particularly well suited for use in ice cream.

A fibre-free ice cream is obtained if the lupins to be employed are flaked before separating the proteins and fibres, for example by means of a roller mill, and thus comparably big lupin particles (lupin flakes) are created, which may simply be separated mechanically after the protein extraction. Grinding the lupin seeds to lupin flour may, on the other hand, result in that many fibrous components remain in the protein extract after the mechanical separation and thus enter the ice cream. Moreover, flaking has the particular advantage that by breaking up the cell structures the aqueous extraction method is more easily accessible to the lupin protein and the lupin oil.

A distinctly creamy ice cream having a highly viscous melt is obtained if an ingredient with a thickening effect is added to the lupin ice cream mixture before freezing. These may be soluble substances, which, in dissolved form and at a sufficient concentration, increase the viscosity of pure water to above 10 mPas, particularly advantageously >100 mPas. The person skilled in the art may revert to a variety of food ingredients for the substances with a thickening effect. Examples are amongst others saccharides such as mono, oligo, or polysaccharides. Employing maltodextrin is particularly advantageous. Employing other natural polymers may be advantageous. Employing such substances in ice cream allows the partial reduction of the fat content in the ice cream without affecting the creaminess. Thus, a fat-reduced vegetable ice cream, which is appealing from a sensory point of view, is made possible.

A particularly suitable lupin ingredient is obtained if acid is added to the aqueous protein solution resulting from the fractioning process after the separation from the fibres. With this, protein and oil containing flakes are precipitated. The oil content of the flakes may be set through the variation of the pH value during precipitation. In a more acid precipitation (e.g. pH=4.5) the oil content of the precipitated protein is lower, at a pH value of 5 the oil content is higher. Thus, through the choice of the pH value, the oil content in the lupin ingredient during precipitation may be influenced.

From a protein-oil ingredient thus precipitated a dry ingredient may be obtained after mechanical thickening, e.g. by means of a decanter, and subsequent drying which may be used for producing an ice cream that is appealing from a sensory point of view.

However, the direct employment of the precipitated aqueous protein-oil ingredient, which, if applicable, has been washed again for reducing the oligosaccharide content, for producing the ice cream, is of particular taste value. Thus, the solubility of the protein remains on a very high level such that the mouth feel is clearly improved due to the lack of undissolved protein particles in the ice cream. The sensory aspect of the ice cream is particularly advantageous if the ingredient contains more than 50% by weight of water before processing the ice cream basic mixture. Still, in individual cases an appropriate ice cream may be produced with a water content of 3 to 5% by weight.

For a multitude of consumers it is advantageous to have the oligosaccharides contained in the lupin seeds largely separated from the lupin ingredient since the oligosaccharides may provoke digestive upsets and in addition generate a bitter taste.

In an advantageous variant for producing a lupin ingredient reduced in oligosaccharides with only a weak bitter taste the flakes containing protein, which were separated from the aqueous phase by means of acid precipitation, are washed again with water. For this it is sensible to use water, in which the pH value has been set to a minimum of protein solubility. Separating the protein from washing water containing oligosaccharides thus preferably occurs by means of centrifugal separating techniques, e.g. by means of a decanter. The process of washing the protein may also be repeated several times in order to achieve a particularly low concentration of oligosaccharides in the protein ingredient.

It is also possible to carry out the process of separating the oligosaccharides from the lupin seed by means of water before the extraction step. Here too, it is sensible to use water, in which the pH value has been set to a minimum of protein solubility. For separating the oligosaccharides crushed lupin seeds or kernels (e.g. lupin flour or lupin flakes) are contacted with water, the oligosaccharides are dissolved in the water and the water is separated from the lupin flour or the lupin flakes. Thereafter, the extraction of the lupin protein may occur. This process too may be repeated several times.

The described protein ingredient from lupins is particularly advantageously added to the ice cream in a concentration of at least 1% by weight, the indication of the mass relating to the protein content in the ingredient. Recipes with 3 to 4% by weight of lupin protein are particularly suitable concentrations. In individual cases it may be advantageous to add up to 10 to 15% by weight of lupin protein to the ice cream.

Also, an ice cream which reduces cholesterol may be obtained particularly advantageously if fractions from the lupin seed, which are separated during production of the described lupin ingredient, are added to the ice cream. They may be the fibre substances or the protein fraction soluble at a pH of 4.5, which may be concentrated through filtration methods and drying methods. These fractions of the lupins have a particularly distinct cholesterol reducing potential; therefore, even small amounts of these substances have a cholesterol reducing effect in humans. Particularly advantageously, the latter soluble protein fraction is added in a higher proportion than present in the native seed compared to the lupin ingredient.

The addition of selected vegetable oil types as additional fat ingredient besides lupin oil allows the production of a healthy ice cream having a balanced proportion of omega 3 and omega 6 fatty acids. Particularly beneficial nutrition-physiological characteristics of the ice cream are obtained if the added oil is rapeseed oil, preferably native rapeseed oil. Oils from sunflowers or from other oil seed are also suitable.

For sweet taste sweeteners such as sugar, glucose syrup, honey or other sweeteners may be added to the ice cream in various weight proportions. Adding flavouring and colouring ingredients allows for a wide variety of flavours. Particularly advantageous for rounding off the slightly nutty flavouring of the lupin protein are flavours with a nutty character, such as, amongst others, walnut, hazelnut, almond or pistachio. An agreeable sense of taste is also achieved by adding additives from strawberry, raspberry, cherry, chocolate or vanilla.

In sensory tests, a particularly tasty ice cream creation has been found to be the flavouring of “lupin”. In addition to the lupin ingredient no taste giving ingredients are added to the ice mixture apart from sugar and vegetable oil.

It may be desirable and to some extent advantageous to add further ingredients to the lupin ice cream, e.g. further vegetable proteins, emulsifiers of vegetable or animal origin or other animal ingredients. The person skilled in the art will be able to choose these from the variety of permissible food ingredients, which are required for achieving a defined sensory characteristic of the ice cream.

All of the ingredients mentioned so far may be produced by conventional methods of ice cream production by mixing, homogenising the ingredients, pasteurising, cooling and maturing of the ice cream mixture and freezing and air dispersion, e.g. in a freezer.

The water may be added either directly or in the form of aqueous solutions, which may already contain flavouring agents or sugar or other ingredients or additives, such as e.g. lemonades, juices or other aqueous solutions.

In a particularly advantageous embodiment native lupin protein is employed as the lupin protein. By native protein it is understood that the protein was not contacted with alcohols or other organic solvents, e.g. hexane, and was not subjected to a thermal treatment above 60° C. before the addition to the ice cream.

A particular consumer acceptance is obtained if products from animal origin are completely dispensed with in the ice cream according to the invention. Thus, in particular the addition of emulsifiers such as mono and diglycerides from animal fats should be avoided or the employment of proteins from animal origin such as albumins, egg proteins, whey proteins, milk proteins, caseins or caseinates such as, e.g., sodium caseinates. In ice cream recipes with vegetable proteins according to the prior art such emulsifiers have been used for achieving a stable emulsion, e.g. products like Coffee-mate® by Nestle, which contains caseinate and/or milk powder. This results in good creaminess, however, it is not a purely vegetable ice cream.

In an advantageous embodiment the ice cream according to the invention contains 40 to 80% by weight of water and 5 to 25% by weight of sugar, particularly preferably 10 to 15% by weight.

In a further advantageous embodiment the ice cream according to the invention contains 1-10% by weight of vegetable protein, preferably 2 to 4% by weight.

In a further advantageous embodiment the ice cream according to the invention contains 3-20% by weight of vegetable oil or vegetable fat, preferably 6 to 12% by weight.

In a particularly advantageous embodiment additives are completely omitted, a declaration of additives (e.g. E no. 471) thus does not apply.

1-24. (canceled)

25. A method for producing a vegetable protein ingredient which is added to ice cream, comprising
providing crushed lupin seeds,
in one or more protein extraction steps, dissolving or dispersing in an aqueous phase a portion of lupin protein contained in the crushed lupin seeds, where in at least one of the protein extraction steps, a pH value of 6≦pH<7 is set for the aqueous phase,
separating out any fibers present in the aqueous phase,
separating out the lupin protein from the aqueous phase to obtain the protein ingredient, and
adding the protein ingredient as a native protein to ice cream.

26. The method according to claim 25, wherein the lupin seeds are crushed as full-fat seed or as hulled seed and are subjected to the one or more protein extraction steps so that the protein ingredient contains a proportion of lupin oil.

27. The method according to claim 25, wherein the crushed lupin seeds are not subjected to an oil extraction process with solvents before the one or more protein extraction steps so that the protein ingredient contains a proportion of lupin oil.

28. The method according to claim 26, wherein the proportion of lupin oil is at least 1.5% by weight in relation to weight of the lupin protein in the protein ingredient.

29. The method according to claim 27, wherein the proportion of lupin oil is at least 1.5% by weight in relation to weight of the lupin protein in the protein ingredient.

30. The method according to claim 25, wherein the pH value for at least one protein extraction step is 6.8 for the aqueous phase.

31. The method according to claim 25, wherein the crushed lupin seeds are obtained by flaking.

32. The method according to claim 25, wherein the protein ingredient has a water content of at least 5% by weight.

33. The method according to claim 25, wherein the protein ingredient has a water content of more than 50% by weight.

34. The method according to claim 25, further comprising washing the crushed lupin seeds before the one or more protein extraction steps to separate out oligosaccharides, wherein the washing is by water having a pH set near minimum solubility of the lupin proteins.

35. The method according to claim 25, wherein the separating out of the lupin protein from the aqueous phase occurs through addition of acid, whereby protein and oil containing flakes are precipitated, oil content of the flakes being set by the pH value and is controllable through the acid in the aqueous phase.

36. The method according to claim 35, wherein the flakes separated out by acid precipitation are washed to separate out oligosaccharides, the pH value of wash water employed being set near minimum solubility of the lupin protein.

37. The method according to claim 25, wherein the lupin seeds are of a lupin species having a reduced fat content of less than 15% by weight in the seed.

38. The method according to claim 25, further comprising adding a proportion of vegetable oil to the lupin protein to obtain the protein ingredient.

39. An ice cream with the protein ingredient produced by the method according to claim 25, 26 or 27.

40. The ice cream according to claim 39, wherein the ice cream contains at least 1% by weight of lupin protein of the protein ingredient.

41. The ice cream according to claim 39, wherein the ice cream contains 3 to 4% by weight of lupin protein of the protein ingredient.

42. The ice cream according to claim 39, wherein the ice cream contains 40 to 80% by weight of water and 5 to 25% by weight of sugar.

43. The ice cream according to claim 39, wherein the ice cream contains 1 to 10% by weight of vegetable protein.

44. The ice cream according to claim 39, wherein the ice cream contains 3 to 20% by weight of vegetable oil or vegetable fat.

45. The ice cream according to claim 39, wherein the ice cream contains 6 to 12% by weight of vegetable oil or vegetable fat.

46. The ice cream according to claim 39, wherein the ice cream contains a thickening ingredient.

47. The ice cream according to claim 39, wherein the ice cream contains one or more fractions of fibers and/or proteins which are precipitated during production of the protein ingredient but not used for the protein ingredient.

48. The ice cream according to claim 39, wherein the ice cream contains no flavor forming ingredients apart from the protein ingredient and sugar.

49. The ice cream according to claim 39, wherein only vegetable ingredients are contained therein.
